(19) United States
(12) Patent Application Publication
(10) Pub. No.: US 2009/0300941 A1
(43) Pub. Date: Dec. 10, 2009

(54) HOUSEHOLD APPLIANCE AND METHOD FOR DRYING A DAMP ITEM

(75) Inventor: Andreas Stolze, Falkensee (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERÄTE GMBH, Munich (DE)

(21) Appl. No.: 12/516,659

(22) PCT Filed: Dec. 12, 2007
(86) PCT No.: PCT/EP2007/063811

§ 371 Date: May 28, 2009

(30) Foreign Application Priority Data
Dec. 22, 2006 (DE) 10 2006 061 212.4

(51) Int. Cl. F26B 3/02; D06F 58/00; D06F 58/04; F26B 19/00; F26B 21/00

(52) U.S. Cl. 34/515; 34/132; 34/131; 34/86; 34/79

(57) ABSTRACT

A household appliance and a method for drying a damp item via an air current are provided. An air current is conducted in a substantially enclosed dry air channel and is driven by a fan. The air current can flow through a treatment chamber with the item, a cooling arrangement for cooling the air current and removing moisture from the air current by condensation after it has flown through the treatment chamber, and a heating arrangement for heating the air current before it flows through the treatment chamber. The cooling arrangement has a first heat exchanger, via which heat from the air current is fed to a process gas that is conducted in a regenerative gas circulation process, and the heating arrangement has a second heat exchanger, via which heat from the process gas is fed to the air current.

The invention relates to household appliance for drying a damp item by means of an air current which can be conducted in a substantially enclosed drying air channel and driven by a fan, with said air current able to flow through a treatment chamber with the item, through a cooling arrangement for cooling the air current and condensing out moisture from the air current after it has passed through the treatment chamber and through a heating arrangement for heating up the air current before it flows through the treatment chamber.

The invention relates equally to a method for drying a damp item by means of an air current which can be conducted in a substantially enclosed drying air channel and driven by a fan, with said air current able to flow through a treatment chamber with the item, through a cooling arrangement for cooling the air current and condensing out moisture from the air current after it has passed through the treatment chamber and through a heating arrangement for heating up the air current before it flows through the treatment chamber.

Such a household appliance is known from the 40 23 000 C2, the 197 38 735 C2 or WO 2006/029953 A1. In each of these documents a corresponding household appliance is described in which the cooling arrangement and the heating arrangement belong to a heat pump, in which in each case a part of the heat which is extracted from the air current in the cooling arrangement is fed back to the air current again in the heating arrangement.

According to the 40 23 000 C2 a compressor heat pump is employed, in which a working medium (carbon dioxide or chlorinated and/or fluorinated hydrocarbon) is compressed into a gaseous state by a compressor, then condensed in a first heat exchanger while emitting heat, then decompressed while passing through a throttle and evaporated in a heat exchanger while emitting heat. Finally it arrives back at the compressor. In accordance with the 197 38 735 C2 a heat pump is employed, in which a first working medium (Ammonia) is periodically absorbed and desorbed in a second working medium (water). According to WO 2006/029953 A1 a heat pump is used in which thermoelectric elements, also referred to as Peltier elements and constructed with specific semiconductor materials, function for transport of the heat.

A washing machine is known from the 1 410 206 A in which washing cannot only be washed but also dried. The publication shows a number of alternatives for the additional devices required for this. An electrical heating facility for heating a current of air used for drying washing and a simple heat exchanger for cooling the heated air current after its application to the washing are provided, with the heater and the cooler also being able to belong to a heat pump device however. The heat pump device can also be designed such that it operates with Peltier elements to exploit the thermoelectric effect.

An apparatus for drying washing from an English abstract belonging to JP 08 057 194 A in the data collection “Patent Abstracts of Japan” contains in its first channel system, in addition to a heater and a cooler, which both belong to a thermoelectrically operable heat pump device, an additional heat exchanger connected upstream from the cooler to the air current conducted away from the washing and an additional heating device connected downstream from the heater for further heating of the air current before it is applied to the washing.

From the documents “Wärmetransformationsprozesse ohne Phasenumwandlung” (heat transformation processes without phase conversion by Dr. Hans-Detlev Kühl, available on 26 Nov. 2006 on the Internet at address http:/hdl.handle.net/2003/2798, see especially pages 1 through 29, a Stirling process and a Vuilleumier process are known as examples of regenerative gas circulation process. Each of these processes is suitable for use in a heat pump or a refrigerator, with applications in energy technology (e.g. in building heating) or for material separation (especially air vaporization and splitting) are cited.

For the Vuilleumier process the reader is also referred to U.S. Pat. No. 1,275,507 of the inventor Rudolph Vuilleumier.

In all generic household appliances with heat pumps which do not use the thermoelectric effect, the take-up and release of heat occurs during the phase transition of the working medium. Specific conditions in respect of pressure and temperature must be adhered to so that the required phase transitions can be achieved and used effectively. This makes the adaptation of heat pumps to the temperature level to be demanded in a household appliance difficult under some circumstances. The thermoelectric heat pump demands the use of unusual expensive semiconductor components and poses specific problems in respect of heat insulation and dry air guidance since heat can only be pumped there via comparatively short spatial distances. This makes the construction of a corresponding household appliance difficult. In addition each known heat pump in a household appliance only reaches the optimal operating conditions relatively slowly when it is started up. This produces an extended time requirement for a drying process which can be felt to be disadvantageous by the user, not least because household appliances with heat pumps are usually sold at very high prices and purchased with correspondingly high expectations.

The object of the invention is to specify a generic household appliance in which, unlike in previously known devices, a recovery of the heat is possible. The object of the invention is also to specify a corresponding generic method.

The object is achieved by a household appliance or a method with the features of the respective independent claim. Preferred embodiments are the subject matter of the independent claims.

The inventive household appliance for drying a damp item by means of an air current able to be conducted in an essentially closed dry air channel and driven by a fan, through which air is able to flow through a treatment chamber with the item, a cooling arrangement for cooling the air current and condensing out moisture from the air current after it has flowed through the treatment chamber and a heating arrangement for heating up the air current before it flows through the treatment chamber is characterized in that the cooling arrangement features a first heat exchanger through which heat is able to be supplied to a process gas conveyed in a regenerative gas circulation process, and the heating arrangement features a second heat exchanger through which heat can be supplied from the process gas to the air current.

The inventive method for drying a damp item by means of an air current able to be conducted in an essentially closed dry air channel and driven by a fan, through which air is able to flow through a treatment chamber with the item, through a cooling arrangement for cooling the air current and condensing out moisture from the air current after it has flowed through the treatment chamber and through a heating arrangement for heating up the air current before it flows through the treatment chamber, is characterized in that heat is supplied in the cooling arrangement from the air current to a process gas conveyed in a regenerative gas circulation process, and heat is supplied in the heating arrangement from the process gas to the air current.

Accordingly, in accordance with the invention, a regenerative gas circulation process is employed to transport heat removed from the air current in the cooling arrangement within the framework of thermodynamic options to the heating arrangement and feed it back into the air current. Under some circumstances such a process does not run in a stationary manner like the circulation process in a compressor heat pump—susceptible to irreversible throttle losses and therefore not regenerative. It also demands a degree of use of mechanics such as pistons as well as associated drives. However with given operating conditions it basically allows the thermodynamic optimum to be approached and thereby also optimum performance values in practice.

Preferably the regenerative gas process is embodied so that it runs in periodically repeating cycle, with the period of a corresponding cycle being significantly smaller than the duration which would be required for regulation drying of an item with the dampness which could usually be expected and the volume that could usually be expected (typical drying process) and for compliance with which the household appliance is thus designed. For an application in a tumble dryer or dishwasher the duration of a typical drying process can be set to a time of the order of magnitude of one hour and a period of a cycle of the regenerative gas process to a time of the order of magnitude of one tenth of a second. A preferred ratio between the duration of the typical drying process and the duration of a period of the regenerative gas process thus lies between 10,000 and 100,000, especially preferably between 30,000 and 40,000.

It is a great advantage for the regenerative gas process not to be dedicated to the use of one working medium which must exhibit phase transitions at specific temperatures and pressures. Therefore the use of chlorinated and/or fluorinated hydrocarbons known from the compressor heat pumps and under some circumstances problematic from the point of view of environmental protection is basically not required. The most essential criterion of the selecting of the working medium is that it behaves as far as possible at the temperatures and pressures considered like an ideal gas. This makes it easier to use gases of simple composition and/or occurring in the normal environment, especially from the aspect of composition which does not cause environmental problems.

The gas-gas heat exchangers basically known from the compressor heat pump are suitable as heat exchangers. These heat exchangers involve—at least in some cases—a gas-gas heat exchanger (if phase transitions also occur in them which do not occur in the regenerative gas circulation processes) which are thus basically intended and suitable for use in the transfer of heat between gases.

A preferred development of the household appliance is characterized in that the process gas is hydrogen or a noble gas, especially helium. Hydrogen and helium are two excellent double or single atomic gases which behave like an ideal gas under the conditions that are usually present in a household appliance. Each noble gas also has the advantage of essentially full chemical inertness. This applies particularly to helium, the simplest noble gas which is accordingly especially preferred.

Likewise preferred are developments of the inventive household appliance such that the first heat exchanger is configured for a direct exchange of heat between the air current and the process gas and/or that the second heat exchanger is configured for a direct exchange of heat between the air current and the process gas. In any event an especially simple layout of the corresponding heat exchanger or of both heat exchangers and also of the household appliance is produced.

Another preferred development of the inventive household appliance makes provision for the first heat exchanger and the second heat exchanger to be the only heat exchanger in the drying air channel. In this household appliance the regenerative gas process is thus the only driver of the drying process for the damp item.

The embodiments in the two previous paragraphs are also intended to make it clear that the embodiments with features other than the preferred developments described in said paragraphs are also possible and are to be considered as belonging to the framework of the invention. In particular it is possible to provide an exchange of heat between the air current and the process gas indirectly, i.e. via an additional means or agent and/or to provide a further heat exchanger and/or an additional heating in the drying air channel. This remark also applies to all other preferred developments of the invention described here.

Likewise preferred is a development of the household appliance such that it contains one heat pump for executing the regenerative gas circulation process, with the first and the second heat exchanger belonging to the heat pump. To this end it is further advantageous for the new household appliance to have two pistons movable respectively in a cylinder for a cyclic movement of the process gas in the heat pump. In this case each piston can have a contactless linear drive. Conceivable as an alternative to such linear drives is a so-called coupling transmission which features a separate crank drive for each piston. In this case the two pistons lie alongside each other as regards their axes of movement or behind one another and the crank drives are arranged so that between the cyclically moved pistons a phase displacement of around 90° exists. As a further alternative the two pistons can be arranged in a V arrangement at an angle of around 90° to each other and the pistons can be articulated on a single crank drive to achieve the necessary phase displacement. The Stirling process or the Vuilleumier process would be able to be realized with this type of arrangement. Also preferred is a development of the household appliance such that the heat pump features a process gas channel through which the process gas is able to be pushed with the process gas channel having a heat reservoir. With such a heat reservoirs, also known as “regenerators” and as such indicative of an optimally designed heat pump, the regenerative gas circulation process is able to be optimized in its function and effect, since the regenerator functions as a store for excess heat and effects a compensation between different temperature levels in part volumes of the process gas adjacent to each other.

A preferred embodiment of the inventive method is characterized in that the regenerative gas circulation process is a Vuilleumier process. This process is based on providing the energy expended for pumping the heat in the form of heat. This process only demands mechanical energy in as far as the gas must be displaced within the closed system in which it is enclosed. The corresponding mechanical devices must therefore only overcome the friction resistance of the flowing gas and the friction that occurs within themselves: the use of mechanical energy is therefore only very small. The Vuilleumier process is therefore not restricted to the use of electrical energy to operate the gas circulation process; the heat energy can if required be provided in another way, for example using a gas or oil burner.

As an alternative to the Vuilleumier process, consideration is also given to embodying the regenerative gas circulation process as a Stirling process. In this context however, instead of the use of heat energy for operating the gas circulation process, a use of mechanical energy is required. However this use can be provided by means of a suitable motor, especially an electric motor, with no unconventional components having to be used in a household appliance and basically existing experience able to be used.

It is of particular advantage for the treatment chamber of the inventive household appliance to be embodied as a rotatable drum, with each further development of the invention described here able to be combined with this development.

Likewise it is especially advantageous for the inventive household appliance to be embodied as a tumble dryer, with each further development of the invention described here also able to be combined with this development.

The preferred developments of the inventive household appliance described individually here correspond to preferred developments of the inventive method and vice versa. Such further developments are not explicitly present under some circumstances or described in detail but must be considered as belonging just as much to the framework of the invention.

Exemplary embodiments of the invention are described below with reference to the drawing. The drawing shows functional sketches from which the present major features emerge. To deduce concrete exemplary embodiments from these functional sketches the reader is referred to the prior art documents cited at the start, especially the documents about tumble dryers and the document by Dr. Hans-Detlev Kühl. The individual figures are as follows

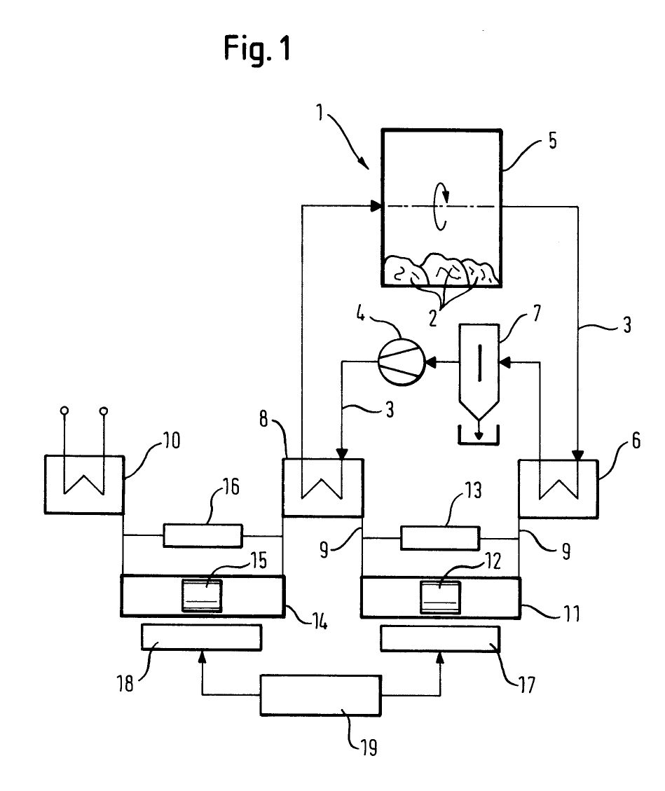

FIG. 1 a household appliance with a Vuilleumier heat pump; and

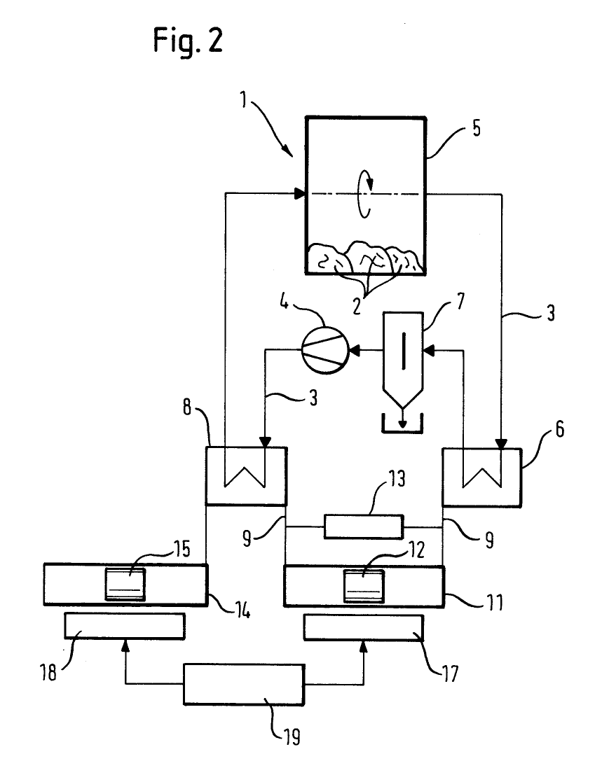

FIG. 2 a household appliance with a Stirling heat pump.

Features of the two figures which correspond to each other have the same reference numbers in each case.

To explain the function of the household appliances shown in the figures the two figures are initially referred to together.

Each figure shows a household appliance 1, this being a tumble dryer 1, intended for drying a damp item 2, namely an item of washing 2. The household appliance 1 has an essentially closed drying air channel 3, in which an air current is conducted. To this end the air current is driven by a fan 4. The damp item 2 is arranged in a treatment chamber 5, with said treatment chamber 5 being embodied in the known way as a rotatable drum 5. After the air current has penetrated the drum 5 it arrives in the drying air channel 3 at the first heat exchanger 6 which functions as a condenser 6. In this the current of air is cooled off until such time as moisture which it has taken up in the drum 5 from the damp item 2 is condensed out. A moisture separator 7, which in the present exemplary embodiments is arranged after the condenser 6, is used for removal from the air current the moisture condensed out of the air current, the moisture removed is collected and is disposed of after the end of the drying of the damp item. It is in line with conventional practice to combine the condenser 6 and the moisture separator 7 more or less in a single component; in the figures in this document these components are shown separately however, above all for the sake of clarity. Behind the condenser 6 and the moisture separator 7 there is the fan 4 already mentioned in the drying air channel 3 which is followed in the drying air channel 3 by a second heat exchanger 8, which is embodied as a heater 8 for the air current. After the air current has passed through the second heat exchanger 8 and has been heated up in the process, it arrives back in the drum where it can again take up moisture from the damp item 2.

In each exemplary embodiment the first heat exchanger 6 and the second heat exchanger 8 are components of a heat pump 6, 8 through 19. In the case of FIG. 1 this is a Vuilleumier heat pump 6, 8 through 19, in the case of FIG. 2 on the other hand it is a Stirling heat pump 6, 8, 9, 11 through 15, 17 through 19. Fundamentals and exemplary embodiments of such heat pumps (and also of other heat pumps with regenerative gas circulation processes) can especially be found in the document by Dr. Hans-Detlev Kühl, and further reference is made to this document.

In the exemplary embodiment according to FIG. 1, which will now be referred to on its own, a Vuilleumier heat pump 6, 8 through 19 is used, which is described in detail below.

The heat pump 6, 8 through 19 contains a process channel 9 in which a suitable process gas and one that largely corresponds at the given temperatures to an ideal gas, namely helium, is enclosed. The process gas channel 9 has a first end at the first heat exchanger 6, which functions at a low temperature level as a heat sink, whereby and while it takes up heat from the air flow in the drying air channel 3, as described. Located within the process channel 9 is the second heat exchanger 8, which functions at an average temperature level as the heat source, whereby and while in supplies the air current in the drying air channel 3 with heat in the way described. Located at a second end of the process gas channel 9 is a heater 10, which is electrically operated and heats up the process gas supplied to it to a high temperature level. The heat arriving in the process gas in this way is that energy which drives the regenerative gas circulation process in the process gas channel 9, in this case a Vuilleumier process. Between the first heat exchanger 6 and the second heat exchanger 8 the process gas channel 9 features a first cylinder 11, in which a first piston 12 is movable. Connected in parallel to the first cylinder 11 is a first regenerator 13, which is a first heat reservoir 13 through which the process gas can largely flow freely. The movement of the first piston 12 pushes the process gas through the first regenerator 13 and can thus be transported from the first heat exchanger 6 to the second heat exchanger 8 or back. In such cases it outputs surplus heat to the first regenerator 13 or takes up possible surplus heat from the latter, in which direction it flows through the first regenerator 13.

Between the second heat exchanger 8 and the heater 10 the process gas channel 9 has a second cylinder 14 with a second piston 15 movable therein as well as, once again connected in parallel to the second cylinder 14, a second regenerator 16. By displacing the second piston 15, process gas is transported by the regenerator 16 from the second heat exchanger 8 to the heater 10 or back, whereby it once again emits surplus heat or takes up missing heat.

Absolutely necessary to operate the Vuilleumier process with the process gas are periodic movements of the first piston 12 and the second piston 15 synchronized with each other and positioned in a well-defined phase relationship to each other. For this purpose a first linear drive 17 is provided for the first piston 12 and a second linear drive 18 for the second piston 15, which is controlled by a control device 19 and displace the pistons 12 and 15 in a contactless manner. This is therefore especially possible in a favorable way because the Vuilleumier process is driven exclusively by the heat energy delivered by the heater 10 and the insertion of mechanical energy via the piston 12 and 15 is only required to the extent that the process gas must be conveyed back and forth between the first heat exchanger 6, the second heat exchanger 8 and the heater 10. In such cases only inertial and frictional forces of the flowing process gas as well as the moving pistons 12 and 15 must be more or less overcome. In particular it is not necessary for the linear drives 17 and 18 the pistons 12 and 15 to touch each other; instead it is actually possible to guide the pistons 12 and 15 without contact by the linear drives 17 and 18. Accordingly it is not necessary to bring moving components out of the process gas channel 9 in a sealed manner; the process gas channel 9 instead forms a completely self-contained and to an extent rigid unit, which can accordingly be sealed in a simple, reliable and durable manner—even when the process gas is under a pressure of up to several hundred bar. This is of great significance for the operational safety and also the durability of the household appliance 1.

The heat pump 6, 8 through 19 is operated in a typical drying process, for which a time of the order of magnitude of one hour would be employed by repeated displacement of the process gas within the process gas channel 9, with the pistons 12 and 15 being moved cyclically and phase-offset from each other with a period of the order of magnitude of one tenth of an hour. A preferred ratio between the drying process and the duration of the period of the regenerative gas process thus lies between 10,000 and 100,000, especially preferably between 30,000 and 40,000.

FIG. 2 shows a household appliance 1 with a Stirling heat pump 6, 8, 9, 11 through 15, 17 through 19 as an alternative to the Vuilleumier heat pump 6, 8 through 19. By comparison with the Vuilleumier heat pump 6, 8 through 19 of FIG. 1 the Stirling-heat pump 6, 8, 9, 11 through 15, 17 through 19 of FIG. 2 lacks the heater 10 and the second regenerator 16. In addition the second cylinder 14 is not contained completely in the process gas channel 9, but instead the process gas channel 9 ends at the second piston 15 in the second cylinder 14. The end of the second cylinder 14 facing away from the second heat exchanger 8 is open. As in the Vuilleumier-heat pump 6, 8 through 19 in accordance with FIG. 1 the pistons 12 and 15 in the Stirling heat pump 6, 8, 9, 11 through 15, 17 through 19 in accordance with FIG. 2 must be moved periodically, synchronized with each other and with a precisely predetermined phase relationship to each other, for which purpose linear drives 17 and 18, controlled by a control device 19, are again provided.

However the Stirling process is not supplied with the energy required for its operation as heat energy but as mechanical energy—it is that energy which is expended by means of the second piston 15 to periodically compress and expand the process gas. The Stirling heat pump 6, 8, 9, 11 through 15, 17 through 19 therefore does not have a heater 10 like the Vuilleumier heat pump 6, 8 through 19, and therefore in the Stirling heat pump 6, 8, 9, 11 through 15, 17 through 19 the second linear drive 18 must be significantly more powerful than the second linear drive 18 in the Vuilleumier heat pump 6, 8 through 19. In addition it is necessary for the process gas channel 9 to be sealed from the second piston 15 movably and under ongoing pressure load by the process gas practically free from leakage. This too demands significant extra effort under some circumstances.

The simpler basic structure of the Stirling heat pump 6, 8, 9, 11 through 15, 17 through 19 contrasts with the lower mechanical demands on the second linear drive 18 of the Vuilleumier heat pump 6, 8 through 19, the Vuilleumier heat pump 6, 8 through 19 is also markedly more flexible in respect of the generation of the heat energy necessary for its operation than the Stirling heat pump 6, 8, 9, 11 through 15, 17 through 19.

In each case the household appliance described here and its preferred exemplary embodiments with use of a regenerative gas circulation process provide the opportunity of using an entirely non-critical working medium as regards functional and safety aspects. In addition high heat pump factors at low temperature levels can be achieved in the corresponding heat pump. In the preferred embodiment with Vuilleumier heat pump with a highest possible temperature difference between the high and low temperature level as well as a comparatively small temperature difference between the average and the low temperature level, a high performance figure can be achieved for the heat pump. This gives the opportunity of creating a household appliance in the form of a tumble dryer which can be assigned to the energy efficiency class A. Corresponding criteria can be taken into account by selection of the process gas and the pressure with which this must be present in the heat pump. The design of the heat reservoir in the heat pump can also favorably influence its operational characteristics.

The invention covers the use of a regenerative gas circulation process in a household appliance for drying a damp item, and thus smoothes the way to the creation of an especially energy-efficient household appliance.

### LIST OF REFERENCE SYMBOLS

1 Household appliance
2 Damp item, washing
3 Drying air duct
4 Fan
5 Treatment chamber, drum
6 First heat exchanger, condenser
7 Moisture separator
8 Second heat exchanger, heater
9 Process gas channel
10 Heater for process gas
11 First cylinder
12 First piston
13 First heat reservoir, first regenerator
14 Second cylinder
15 Second piston
16 Second heat reservoir or second regenerator
17 First linear drive
18 Second linear drive
19 Control device

1-18. (canceled)

19. A household appliance for drying a damp item, the household appliance comprising:
a substantially closed drying air channel through which an air current can be driven via a fan, the air channel having a treatment chamber for retaining a damp item to be dried, a cooling arrangement for cooling the air current and condensing out moisture from the air current after it has flowed through the treatment chamber, and a heating arrangement for heating up the air current before it flows again through the treatment chamber, the air current flowing sequentially through the treatment chamber, thereafter through the cooling arrangement for cooling the air current and condensing out moisture from the air current after it has flowed through the treatment chamber, and thereafter through the heating arrangement for heating up the air current before it flows again through the treatment chamber, the cooling arrangement having a heat exchanger, and the heating arrangement having a heat exchanger; and
a process gas device containing process gas that is circulated in a regenerative gas circulation process, the heat exchanger of the cooling arrangement extracting heat from the air current and providing such heat to the process gas and the heat exchanger of the heating arrangement providing heat furnished by the process gas to the air current.

20. The household appliance as claimed in claimed 19, wherein the process gas is a selected one of hydrogen, a noble gas that is not helium, or helium.

21. The household appliance as claimed in claimed 19, wherein the heat exchanger of the cooling arrangement is configured for a direct heat exchange between the air current and the process gas.

22. The household appliance as claimed in claimed 19, wherein the heating arrangement having a heat exchanger is configured for a direct heat exchange between the air current and the process gas.

23. The household appliance as claimed in claimed 19, wherein the heat exchanger of the cooling arrangement and the heating arrangement having a heat exchanger are the only heat exchangers in the drying air channel.

24. The household appliance as claimed in claimed 19 and further comprising a heat pump for executing the regenerative gas circulation process, with the heat exchanger of the cooling arrangement and the heating arrangement having a heat exchanger being operatively associated with the heat pump.

25. The household appliance as claimed in claim 24, wherein the heat pump includes two pistons each movable in a respective cylinder for effecting cyclic displacement of the process gas.

26. The household appliance as claimed in claimed 24, wherein the heat pump includes a process gas channel through which the process gas is displaced and the process gas channel includes at least one heat reservoir.

27. The household appliance as claimed in claimed 24, wherein the heat pump is configured to assist in a Vuilleumier process.

28. The household appliance as claimed in claim 27, wherein the heat pump includes an electrical heater for the process gas.

29. The household appliance as claimed in claimed 24, wherein the heat pump is configured to assist in a Stirling process.

30. The household appliance as claimed in claimed 19, wherein the treatment chamber is a rotatable drum.

31. The household appliance as claimed in claimed 19, wherein the treatment chamber is configured as a treatment chamber for a tumble dryer.

32. A method for drying a damp item, the method comprising:
guiding an air current in an essentially closed drying air channel with the air current flowing through a treatment chamber with a damp item therein, through a cooling arrangement for cooling the air current and condensing out moisture from the air current after it has flowed through the treatment chamber, and through a heating arrangement for heating up the air current before it flows again through the treatment chamber;
extracting heat via a heat exchanger in the cooling compartment as the air current flows through the cooling arrangement;
providing heat extracted from the air current by the heat exchanger in the cooling compartment to a process gas conveyed in a regenerative gas circulation process; and
supplying heat via a heat exchanger in the heating arrangement to the air current as the air current flows through the heating arrangement, the heat exchanger in the heating arrangement obtaining heat from the process gas to be supplied to the air current.

33. The method as claimed in claim 32, wherein the regenerative gas circulation process is a Vuilleumier process.

34. The method as claimed in claim 32, wherein the regenerative gas circulation process is a Stirling process.

35. The method as claimed in claim 32, wherein the regenerative gas circulation process is repeated cyclically with a specific period, and in which a duration for a typical drying process is predetermined, with a ratio between the duration and the period lying between 10,000 and 100,000.

36. The method as claimed in claim 35, wherein the ratio lies between 30,000 and 40,000.
